(19) United States
(12) Patent Application Publication
(10) Pub. No.: US 2021/0300210 A1
(43) Pub. Date: Sep. 30, 2021

(54) VEHICLE

(71) Applicant: HONDA MOTOR CO., LTD., Tokyo (JP)

(72) Inventors: Mai NUMAZAWA, Wako-shi (JP); Kei KOBAYASHI, Wako-shi (JP); Kotone NAKAO, Wako-shi (JP); Tomohiro ITO, Wako-shi (JP); Kazutaka NAKABE, Wako-shi (JP)

(73) Assignee: HONDA MOTOR CO., LTD., Tokyo (JP)

(21) Appl. No.: 17/209,647

(22) Filed: Mar. 23, 2021

(30) Foreign Application Priority Data
Mar. 30, 2020 (JP) 2020-060452

(51) Int. Cl. B60N 2/01

(52) U.S. Cl. CPC B60N 2/01

(57) ABSTRACT

A vehicle includes a first seat, a second seat, and an article placement part. The first seat and the second seat are disposed to face each other in a vehicle room. The article placement part is disposed around at least one of the first seat and the second seat. A high contrast part having a high brightness and a high saturation relative to another interior component is provided on a member surface which becomes a back portion of an article that is placed on the article placement part.

### CROSS-REFERENCE TO RELATED APPLICATION

Priority is claimed on Japanese Patent Application No. 2020-060452, filed on Mar. 30, 2020, the contents of which are incorporated herein by reference.

### BACKGROUND

### Field of the Invention

The present invention relates to a vehicle which includes a plurality of seats in a passenger compartment.

### Background

As a vehicle which includes a plurality of seats in a passenger compartment, a vehicle has been proposed in which a tray for placing an article is formed integrally on a back surface of part of the seats (for example, refer to Japanese Unexamined Utility Model Application, First Publication No. S58-041637).

In the vehicle described in Japanese Unexamined Utility Model Application, First Publication No. S58-041637, the tray for placing an article is formed integrally on a back surface of a backrest of a rear seat. The tray for placing an article is integrally formed of a frame material made of a resin of the backrest.

The tray for placing an article is set to have a color tone and a material quality that do not cause a person to feel strange in comparison with a surrounding interior.

### SUMMARY

In the vehicle described in Japanese Unexamined Utility Model Application, First Publication No. S58-041637, when part of the rear seat is used as an article placement part (a tray for placing an article), the article placement part does not cause a person to feel strange in comparison with the surrounding interior, but on the contrary, there is a concern that an occupant may forget an article that is placed on the article placement part at the time of getting off or the like.

An aspect of the present invention provides a vehicle that is capable of preventing a person from forgetting an article that is placed on an article placement part.

A vehicle according to an aspect of the present invention includes: a first seat and a second seat that are disposed to face each other in a vehicle room; and an article placement part that is disposed around at least one of the first seat and the second seat, wherein a high contrast part having a high brightness and a high saturation relative to another interior component is provided on a member surface which becomes a back portion of an article that is placed on the article placement part.

According to the configuration described above, when an article such as a small object is placed on the article placement part, since the member surface which becomes the back portion is the high contrast part, the article that is placed on the article placement part is shown up. Therefore, it is possible to prevent an occupant from forgetting the article that is placed on the article placement part.

The first seat may be constituted of a front seat that is disposed to face rearward in a travel direction, the second seat may be constituted of a rear seat that is disposed, at a rearward side of the front seat, to face frontward in the travel direction, and the article placement part may be disposed around the rear seat.

In this case, when an article such as a small object is placed on the article placement part around the rear seat, the article is shown up relative to the back portion of the article placement part, which is the high contrast part.

The front seat may be constituted of a side-by-side seat in which a plurality of seats are laterally aligned side-by-side in one row and each of the seats is capable of being flipped up, and the high contrast part may be provided on a rear surface of the seat of the front seat.

In this case, when a seat of the front seat on which an occupant is not seated is flipped up, the high contrast part of the rear surface of the seat faces toward an occupant side of the rear seat. Therefore, when an article such as a trunk is placed at a vehicle rearward side of the seat that is flipped up, the article which is placed such that the high contrast part is the background is shown up. Therefore, it is possible to prevent an occupant from forgetting the article which is placed at a rearward position of the seat of the front seat that is flipped up.

The high contrast part may be colored in a yellow system, and the other interior component may be colored in a gray system.

In this case, it is possible to further show up the article that is placed on the article placement part.

A height of the lowest end part of a seat surface of the rear seat may be set to be higher than a height of the lowest end part of a seat surface of the front seat.

In this case, when occupants are seated on the front seat and the rear seat in a face-to-face state, a visual line height of an occupant seated on the front seat and a visual line height of an occupant seated on the rear seat are different from each other. Therefore, the occupants seated to face each other tend not to worry about the visual line of another occupant. Further, since the visual line height of the occupant seated on the rear seat becomes higher relative to the occupant seated on the front seat, a front sight of the occupant seated on the rear seat is improved.

Further, the occupant seated on the front seat and facing rearward tends to easily get motion sickness due to shaking at the time of traveling of the vehicle. However, in the present configuration, since the height of the lowest end part of the seat surface of the front seat is set to be low, the occupant seated on the front seat and facing rearward is strongly pressed against a backrest, and the shaking of the body at the time of traveling of the vehicle is prevented. Accordingly, in a case where the present configuration is employed, it is possible to prevent the motion sickness of the occupant seated on the front seat.

According to an aspect of the present invention, since the member surface which becomes the back portion of the article that is placed on the article placement part is the high contrast part, the article that is placed on the article placement part is shown up, and it is possible to prevent an occupant from forgetting the article.

### BRIEF DESCRIPTION OF THE DRAWINGS

FIG. 1 is a side view schematically showing an inside of a vehicle according to an embodiment.

FIG. 2 is a top view schematically showing the inside of the vehicle according to the embodiment.

FIG. 3 is a side view schematically showing the inside of the vehicle according to the embodiment.

FIG. 4 is a perspective view showing a rear seat and the vicinity of the rear seat of the vehicle according to the embodiment.

FIG. 5 is a perspective view showing the rear seat and the vicinity of the rear seat of the vehicle according to the embodiment.

FIG. 6 is a front view showing a front seat in which a seat is flipped up of the vehicle according to the embodiment.

### DESCRIPTION OF EMBODIMENTS

Hereinafter, an embodiment of the present invention will be described with reference to the drawings. In the drawings, an arrow FR that indicates a frontward direction of a vehicle 1, an arrow UP that indicates an upward direction of the vehicle 1, and an arrow LH that indicates a leftward direction of the vehicle 1 are shown.

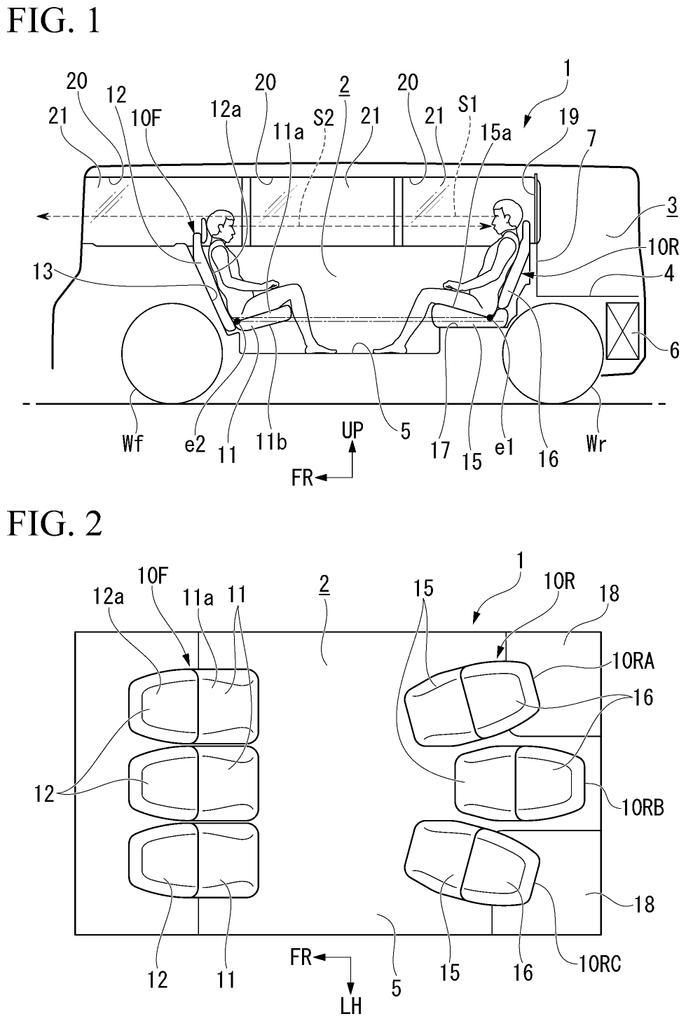

FIG. 1 is a side view of the vehicle 1 of the embodiment schematically showing an inside of the vehicle. FIG. 2 is a top view of the vehicle 1 of the embodiment schematically showing the inside of the vehicle.

The vehicle 1 is an automated driving vehicle capable of unmanned traveling, and a passenger compartment 2 on which an occupant boards is broadly ensured in a middle region in a vehicle front-to-rear direction. Specifically, the passenger compartment 2 extends in the front-to-rear direction from a rear position of a front wheel Wf to the vicinity of a substantially middle position of a rear wheel Wr.

A load room 3 in which a load can be loaded from a vehicle rearward side is formed at a rearward position of the passenger compartment 2. The passenger compartment 2 and the load room 3 are partitioned by a partition wall 7. A floor part 4 of the load room 3 is set to be higher than a floor part 5 of the passenger compartment 2. The floor part 4 of the load room 3 is disposed at a higher position than the rear wheel Wr. A battery, a control circuit, and the like (drive system device 6, not shown) that drive a motor for driving the vehicle is disposed below the floor part 4 of the load room 3. A mirror body 19 that reflects the vehicle frontward side is attached to a front surface of the partition wall 7.

A front seat 10F of a side-by-side seat type (bench seat type) in which a plurality of seats 11 are laterally aligned side-by-side in one row is disposed on a front side in the passenger compartment 2. A rear seat 10R of an independent seat type in which adjacent seats are capable of being arranged to be offset in the vehicle front-to-rear direction is disposed on a rear side in the passenger compartment 2. In the present embodiment, the front seat 10F constitutes a first seat, and the rear seat 10R constitutes a second seat.

The front seat 10F is disposed such that three seats 11 are aligned side-by-side in a lateral direction. A backrest 12 that corresponds to each seat 11 of the front seat 10F is fixed to a frame 13 on a vehicle body front side in a state of being inclined frontward at a predetermined angle. Each seat 11 of the front seat 10F is capable of being flipped upward such that a front end side of the seat 11 is a rotation fulcrum point. The number of seats 11 of the front seat 10F may be two or more and is not limited to three.

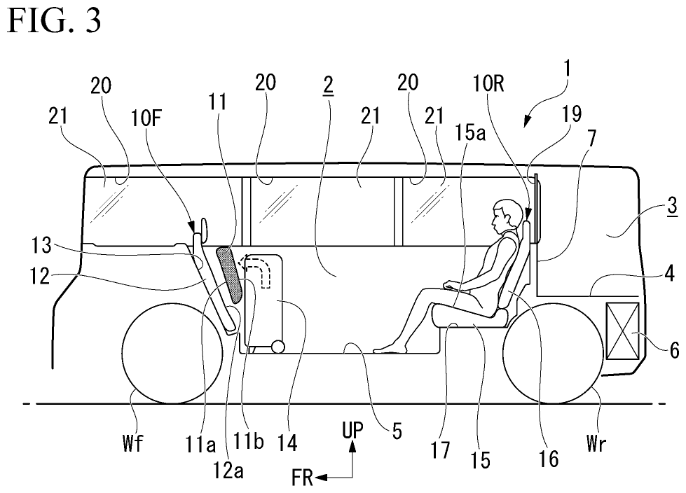

FIG. 3 is a side view of the vehicle 1 similar to FIG. 1 showing a state where the seat 11 of the front seat 10F is flipped up in an upward direction.

In a state where each seat 11 of the front seat 10F is flipped up in the upward direction, a seat surface 11a faces a backrest surface 12a of the backrest 12, and a rear surface 11b is directed toward the rear seat 10R side (vehicle rearward side) in a state of being inclined upward toward the vehicle rearward side. The floor part 5 of the passenger compartment 2 is constituted of a flat surface that extends from the vicinity of a front part of the rear seat 10R to a lower position of a front end part of the backrest 12 of the front seat 10F. Therefore, as shown in FIG. 3, it is possible to place a large load 14 (article) such as a suitcase in a space above the floor part 5 that is formed when the seat 11 of the front seat 10F is flipped up.

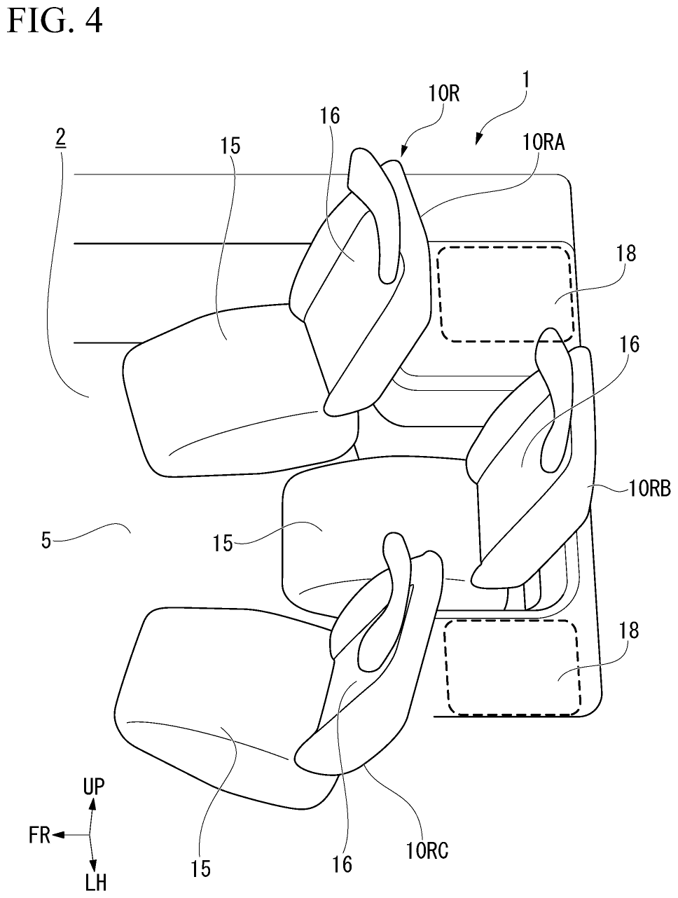

FIG. 4 is a perspective view showing the rear seat 10R in the passenger compartment 2.

In the rear seat 10R, three seat blocks 10RA, 10RB, and 10RC constituted of a pair of the seat 15 and the backrest 16 are disposed to be spaced apart from each other in a vehicle width direction. In the two seat blocks 10RA and 10RC that are disposed at the outside in the vehicle width direction, each seat 15 is disposed to be inclined inward in the vehicle width direction relative to the vehicle frontward direction. The seat block 10RB at the middle in the vehicle width direction is disposed to face straight in the vehicle frontward direction. Further, the seat block 10RB at the center in the vehicle width direction is disposed to be offset to the vehicle rearward side relative to the two seat blocks 10RA and 10RC at the outside in the vehicle width direction.

In the present embodiment, the three seat blocks 10RA, 10RB, and 10RC are disposed to be fixed to a frame 17 in the vehicle room. However, each of the blocks 10RA, 10RB, and 10RC may be movably disposed on the floor part 5 via a seat rail or the like.

Further, an article storage part 18 is disposed at a rearward position of each of the two seat blocks 10RA and 10RC at the outside in the vehicle width direction in the passenger compartment 2. An article can be stored in the article storage part 18. An article can be also placed on an upper surface side of the article storage part 18.

Further, as shown in FIG. 1, the height of the lowest end part e1 of a seat surface 15a of the rear seat 10R disposed in the passenger compartment 2 is set to be higher than the height of the lowest end part e2 of the seat surface 11a of the front seat 10F. Therefore, when occupants are seated on the front seat 10F and the rear seat 10R in the face-to-face state, the visual line height of the occupant seated on the rear seat 10R becomes higher relative to (the visual line height of) the occupant seated on the front seat 10F.

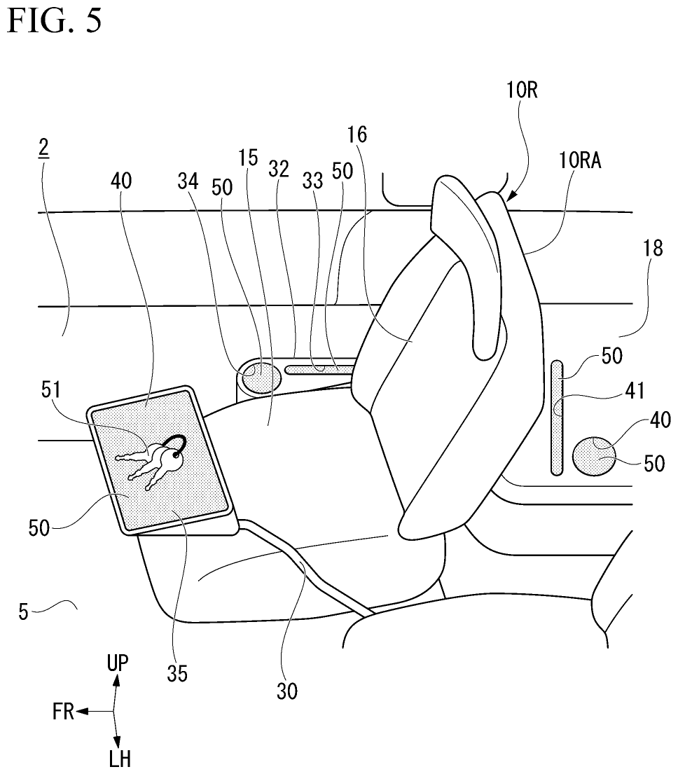

FIG. 5 is a perspective view showing a seat block 10RA and the vicinity of the seat block 10RA at the outside in the vehicle width direction of the rear seat 10R of the vehicle.

A support arm 30 that supports a table 35 which is an article placement part is disposed on an inner side part in the vehicle width direction of the seat block 10RA and protrudes toward a frontward side of the seat 15. In the case of the present embodiment, the table 35 is detachably attached to the support arm 30.

A storage block 32 which also serves as an armrest is disposed on an outer side part in the vehicle width direction of the seat block 10RA. A storage pocket 33 in which the detached table 35 is stored and a cup holder 34 in which a drink can be placed are formed on a top surface of the storage block 32. In the present embodiment, the storage pocket 33 and the cup holder 34 also constitute the article placement part. Further, a cup holder 40 which is the article placement part and a storage pocket 41 which is the article placement part are also formed in an article storage part 18 that is disposed on a rearward side of the seat block 10RA.

Here, an upper surface of the table 35 is a part on which a variety of articles 51 are placed and is also a member surface visible as a back portion of the placed article 51. A color having a high brightness and a high saturation relative to another interior component is provided on the upper surface of the table 35. The upper surface of the table 35 on which the color is provided constitutes a high contrast part 50 in the present embodiment.

Further, a cup as an article may be placed inside of the cup holders 34 and 40 of the storage block 32 and the article storage part 18. Circumferential edge parts of the cup holders 34 and 40 are a member surface visible as a back portion of the cup. A color having a high brightness and a high saturation relative to another interior component is provided on the circumferential edge part of each of the cup holders 34 and 40. An article such as the table 35 is placed inside of the storage pockets 33 and 41 of the storage block 32 and the article storage part 18. Circumferential edge parts of the storage pockets 33 and 41 are a member surface visible as a back portion of the stored article. A color having a high brightness and a high saturation relative to another interior component is provided on the circumferential edge part of each of the storage pockets 33 and 41.

The circumferential edge part of each of the cup holders 34 and 40 and the circumferential edge part of each of the storage pockets 33 and 41 on which the color described above is provided constitute a high contrast part 50 in the present embodiment.

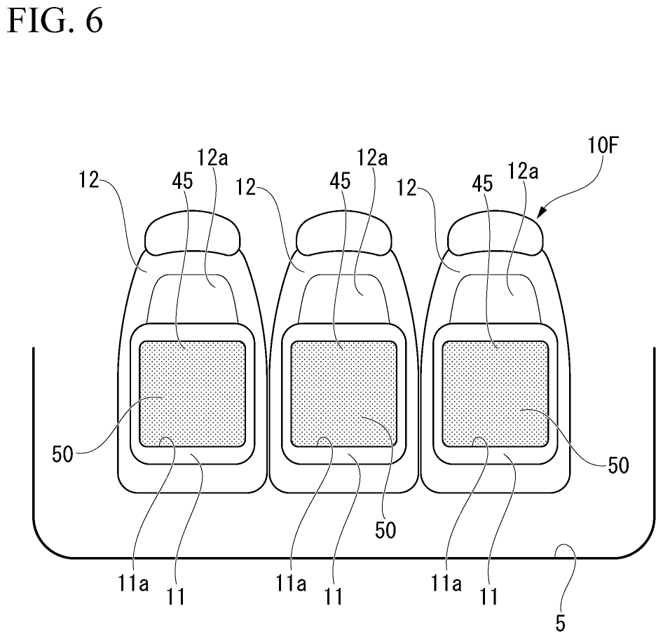

FIG. 6 is a front view showing the front seat 10F in which the seat 11 is flipped up.

A color having a high brightness and a high saturation relative to another interior component is provided on the rear surface 11b of the seat 11 which is flipped up. The floor part 5 below the seat 11 which is flipped up is a part on which a large load 14 (article) such as a trunk is placed. The rear surface 11b of the seat 11 which is flipped up is a member surface visible as a back portion of the load 14. The part of the rear surface 11b of the seat 11 on which the color having a high brightness and a high saturation is provided constitutes a high contrast part 50 in the present embodiment.

In the case of the present embodiment, each of the high contrast parts 50 described above is colored in a yellow system, and the other interior component is colored in a gray system.

As described above, in the vehicle 1 of the present embodiment, the back portion (member surface) of the article placement part such as the table 35, the storage pockets 33 and 41, the cup holders 34 and 40, and the floor 5 is the high contrast part 50. Therefore, an article placed on the article placement part is shown up relative to the surroundings. Accordingly, in a case where the vehicle 1 of the present embodiment is employed, it is possible to prevent an occupant from forgetting the article.

Further, in the vehicle 1 of the present embodiment, the front seat 10F is constituted of the side-by-side seat in which the seat 11 is capable of being flipped up, and the high contrast part 50 is provided on the rear surface 11b of the seat 11. Therefore, when the load 14 (article) such as a trunk is placed at the vehicle rearward side of the seat 11 that is flipped up, the load 14 (article) which is placed such that the high contrast part 50 is the background can be remarkably seen.

Therefore, it is possible to prevent an occupant from forgetting the load 14 (article) which is placed at the rearward position of the seat 11 that is flipped up.

Further, in the vehicle 1 of the present embodiment, the high contrast part 50 is colored in a yellow system, and the other interior component is colored in a gray system. Therefore, it is possible to further show up the article that is placed on the article placement part.

Further, in the vehicle 1 of the present embodiment, the height of the lowest end part e1 of the seat surface 15a of the rear seat 10R is set to be higher than the height of the lowest end part e2 of the seat surface 11a of the front seat 10F. Therefore, when occupants are seated on the front seat 10F and the rear seat 10R in a face-to-face state, the height of the visual line s1 of an occupant seated on the rear seat becomes higher than the height of the visual line s2 of an occupant seated on the front seat 10F. Accordingly, in a case where the present configuration is employed, the occupants seated to face each other tend not to worry about the visual line of another occupant. Further, since the height of the visual line s1 of the occupant seated on the rear seat 10R becomes higher relative to the upper body of the occupant seated on the front seat 10F, the front sight of the occupant seated on the rear seat 10R is improved.

Further, in the vehicle 1 of the present embodiment, since the height of the lowest end part e2 of the seat surface 11a of the front seat 10F is low, the occupant seated on the front seat 10F and facing rearward is strongly pressed against the backrest 12, and shaking of the occupant's body when the vehicle is traveling is prevented. Accordingly, when the vehicle 1 of the present embodiment is employed, it is possible to prevent the occupant seated on the front seat 10F from experiencing motion sickness.

The present invention is not limited to the embodiment described above, and various design changes can be made without departing from the scope of the invention.

What is claimed is:

1. A vehicle, comprising:
a first seat and a second seat that are disposed to face each other in a vehicle room; and
an article placement part that is disposed around at least one of the first seat and the second seat,
wherein a high contrast part having a high brightness and a high saturation relative to another interior component is provided on a member surface which becomes a back portion of an article that is placed on the article placement part.

2. The vehicle according to claim 1,
wherein the first seat is constituted of a front seat that is disposed to face rearward in a travel direction,
the second seat is constituted of a rear seat that is disposed, at a rearward side of the front seat, to face frontward in the travel direction, and
the article placement part is disposed around the rear seat.

3. The vehicle according to claim 2,
wherein the front seat is constituted of a side-by-side seat in which a plurality of seats are laterally aligned side-by-side in one row and each of the seats is capable of being flipped up, and
the high contrast part is provided on a rear surface of the seat of the front seat.

4. The vehicle according to claim 1,
wherein the high contrast part is colored in a yellow system, and the other interior component is colored in a gray system.

5. The vehicle according to claim 2,
wherein the high contrast part is colored in a yellow system, and the other interior component is colored in a gray system.

6. The vehicle according to claim 3,
wherein the high contrast part is colored in a yellow system, and the other interior component is colored in a gray system.

7. The vehicle according to claim 2,
wherein a height of the lowest end part of a seat surface of the rear seat is set to be higher than a height of the lowest end part of a seat surface of the front seat.

8. The vehicle according to claim 3,
wherein a height of the lowest end part of a seat surface of the rear seat is set to be higher than a height of the lowest end part of a seat surface of the front seat.
